(19) United States
(12) Patent Application Publication
(10) Pub. No.: US 2020/0104799 A1
(43) Pub. Date: Apr. 2, 2020

(54) IDENTIFYING FAKE POSITIONS

(71) Applicant: Microsoft Technology Licensing, LLC, Redmond, WA (US)

(72) Inventors: Juliette Xiong, Phoenix, AZ (US); Hitesh Kumar, San Francisco, CA (US); Michael M. Jennings, San Francisco, CA (US)

(73) Assignee: Microsoft Technology Licensing, LLC, Redmond, WA (US)

(21) Appl. No.: 16/146,669

(22) Filed: Sep. 28, 2018

(51) Int. Cl. G06Q 10/10; G06F 17/27; G06F 17/30; G06K 9/62; G06F 15/18

(52) U.S. Cl. CPC G06Q 10/1053; G06F 17/2785; G06F 15/18; G06K 9/6262; G06F 17/30867

(57) ABSTRACT

The disclosed embodiments provide a system for identifying fake positions in member profiles. During operation, the system determines features and labels for real positions and fake positions listed in member profiles with an online network, wherein the features indicate inclusion of one or more attributes in the member profiles. Next, the system inputs the features and the labels as training data for a machine learning model. The system then applies the machine learning model to additional features for additional members with the online network to produce scores representing likelihoods that positions listed in additional member profiles for the additional members are fake. Finally, the system stores predictions represented by the scores in association with the positions.

### BACKGROUND

### Field

The disclosed embodiments relate to techniques for identifying fake positions.

### Related Art

Online networks may include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, and/or search and apply for jobs.

In turn, online networks may facilitate activities related to recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for identifying fake positions in member profiles in accordance with the disclosed embodiments.

FIG. 3 shows a flowchart illustrating a process of identifying fake positions in member profiles in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for identifying fake positions in member profiles. The member profiles may be created and/or listed within an online network, such as an online professional network that allows professionals, companies, schools, and/or other entities to interact with one another in a professional and/or business context. A member profile may contain user-provided attributes, such as a name, profile photo, professional headline, summary, skills, endorsements, recommendations, educational background, employer, and/or one or more positions with the employer. A position in a member profile may be fake when the member profile does not belong to a real user, the member profile belongs to an impersonator, and/or the position is not or was not actually occupied by the member represented by the member profile.

A machine learning model is used to classify a position listed in a member profile as real or fake based on features associated with the member profile. Such features may relate to professional signals derived from the member profile and/or the member's current or past positions. For example, the features may identify whether the member profile contains attributes such as educational background, a profile picture, and/or a summary. The features may also, or instead, include the number of skills listed in the member profile, the number of connections at the current employer listed in the member profile, and/or the number of profile views of the member profile. The features may also, or instead, include a ratio of a certain type of position (e.g., a C-level position, a senior management position, a mid-level position, an entry-level position, an engineering position, etc.) to all positions listed in the member profile. In general, the features may be selected based on positive or negative correlations with fake positions in member profiles.

The machine learning model may be trained using member profiles with positions that are labeled as real or fake. A position may be labeled as fake when the number of member profiles listing the position at a given company exceeds a threshold and/or the number of connections associated with the member profile in the online network falls below another threshold. A position may be labeled as real when the corresponding member profile includes a confirmed email address for a company and/or is accessed through an Internet Protocol (IP) address of the company.

The machine learning model may then be applied to additional features for other member profiles and/or positions to classify positions in the member profiles as real or fake. For example, the machine learning model may include a classification model that outputs scores representing the likelihoods that the positions are fake. The scores and/or corresponding classifications may be stored in association with the positions, used to filter the fake positions from a data store and/or query results returned by the data store, used to improve the accuracy of metrics calculated from the positions, and/or used to trigger the editing or removal of profiles suspected to include fake positions.

By identifying fake positions in member profiles based on attributes associated with the member profiles, the disclosed embodiments may improve the accuracy of data listed in the member profiles, insights derived from the member profiles, and user trust in the accuracy of the data. In contrast, conventional techniques for verifying position data include requiring a member to provide proof (e.g., records) of holding a position. However, obtaining the proof is typically difficult and leads to a negative user experience with the online system. Another conventional way of verifying position data is to have employment verifications performed by third parties. However, such employment verifications take an extended period of time (e.g., weeks) and can be error prone and costly. Consequently, the disclosed embodiments may improve computer systems and technologies related to use of online networks, verifying member profile data in an efficient and highly accurate manner, and/or deriving insights from member profile data or online networks, as well as user engagement, user experiences, interaction, and/or value derived through the online networks, member profiles, and/or insights.

### Identifying Fake Positions in Member Profiles

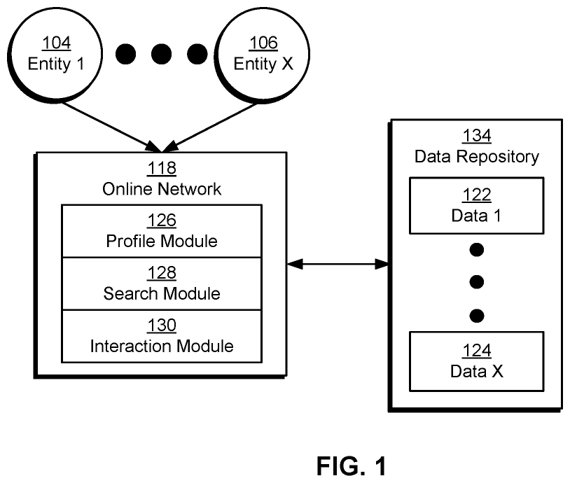

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

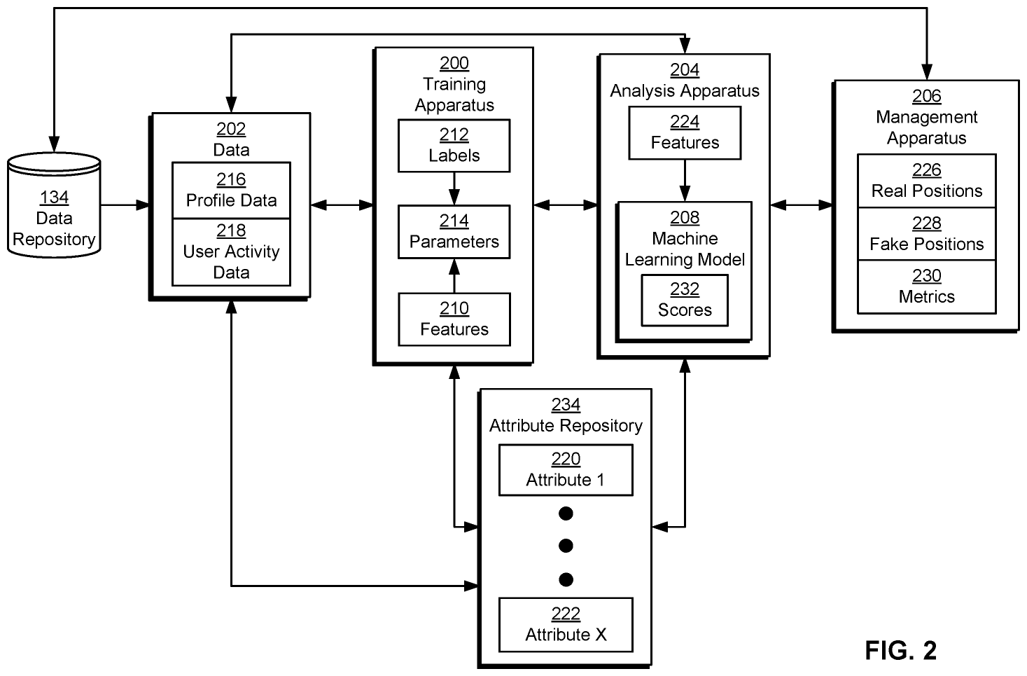

As shown in FIG. 2, data repository 134 and/or another primary data store may be queried for data 202 that includes profile data 216 for members of an online community (e.g., online network 118 of FIG. 1), as well as user activity data 218 that tracks the members' activity within and/or outside the online community. Profile data 216 includes data associated with member profiles in the online community. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online community.

Attributes of the members from profile data 216 may be matched to a number of member segments, with each member segment containing a group of members that share one or more common attributes. For example, member segments in the online community may be defined to include members with the same industry, title, location, and/or language.

Connection information in profile data 216 may additionally be combined into a graph, with nodes in the graph representing entities (e.g., users, schools, companies, locations, etc.) in the online community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of member interactions with one another and/or content associated with the online community. For example, user activity data 218 may track impressions, clicks, likes, dislikes, shares, hides, comments, posts, updates, conversions, and/or other user interaction with content in the online community. User activity data 218 may also track other types of activity, including connections, messages, and/or interaction with groups or events. Like profile data 216, user activity data 218 may be used to create a graph, with nodes in the graph representing online community members and/or content and edges between pairs of nodes indicating actions taken by members, such as creating or sharing articles or posts, sending messages, sending or accepting connection requests, joining groups, and/or following other entities.

In one or more embodiments, attribute repository 234 stores data that represents standardized, organized, and/or classified attributes (e.g., attribute 1 220, attribute x 222) in profile data 216 and/or user activity data 218. For example, skills in profile data 216 and/or user activity data 218 may be organized into a hierarchical taxonomy that is stored in attribute repository 234 and/or another repository. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in attribute repository 234 may include cities, metropolitan areas, states, countries, continents, and/or other standardized geographical regions. In a third example, attribute repository 234 includes standardized company names for a set of known and/or verified companies associated with the members and/or jobs. In a fourth example, attribute repository 234 includes standardized titles, seniorities, and/or industries for various jobs, members, and/or companies in the social network. In a fifth example, attribute repository 234 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

In one or more embodiments, the system of FIG. 2 uses profile data 216 and/or user activity data 218 from data repository 134 to identify real positions 226 and fake positions 228 in profiles of the members. For example, data 202 in data repository 134 and/or standardized versions of the data in attribute repository 234 may be aggregated and/or analyzed to determine if senior-level positions (e.g., vice president, C-level positions, etc.) and/or other types of positions listed in the profiles are real or fake.

Each position may be represented by a number of attributes in profile data 216. For example, a position may be uniquely identified by a name of a member holding the position, a job title associated with the position, and a company at which the position is held. Each position may be assigned a unique position identifier to distinguish the position from other positions with the same or similar member name, job title, and/or company. Moreover, a position may be fake if the member, job title, and/or company are incorrect and/or the member profile in which the position is listed is fake.

A training apparatus 200 inputs features 210 and labels 212 associated with real positions 226 and fake positions 228 in profile data 216 as training data for a machine learning model 208. Labels 212 may identify positions in a set of member profiles as real or fake. For example, a position in a member profile may be assigned a label of 1 if the position is determined to be fake and a label of 0 if the position is determined to be real.

Training apparatus 200 and/or another component of the system may generate labels 212 based on attributes in profile data 216, user activity data 218, and/or other data 202 in data repository 134. First, the component may generate positive labels 212 (i.e., labels for fake positions) by applying a number of filters and/or thresholds to the attributes. For example, the component may label a senior-level position in a member profile as fake when the position is at a company with over 100 employees, the title associated with the position is found in over 100 positions at the company, and/or the member profile has less than or equal to 20 connections within the online community. In another example, the component may obtain positive labels 212 from users that compare positions and/or member profiles in data repository 134 with publicly available data for prominent employees of a company.

Second, the component may generate negative labels 212 (i.e., labels for real positions) based on attributes that verify the identities and/or positions of the corresponding member profiles. For example, the component may label a senior-level position listed in member profiles from data repository 134 as real when the member profiles are on a whitelist of “verified” identities, each member profile includes a confirmed email address for a company listed as an employer, and/or the member profile has been accessed through an IP address of the company.

Training apparatus 200 and/or the component may also generate features 210 associated with labels 212. Features 210 may include attributes in profile data 216 that are positively or negatively correlated with fake positions 228. For example, features 210 may indicate if a member profile includes attributes such as an educational background, profile picture, and/or summary Features 210 may also, or instead, indicate if a member profile is visible or hidden. Features 210 may also, or instead, include a number of skills listed in a member profile, a number of connections the member has with an employer listed in the member profile, a number of profile views of the member profile, and/or a ratio of senior-level positions (or other types of positions) in the member profile to all positions in the member profile. Features may also, or instead, include the number of positions listed in a member profile and/or a capitalization of a name in the member profile (e.g., if the name is in all lowercase or all uppercase letters).

Those skilled in the art will appreciate that labels 212 and/or features 210 may be generated in other ways. For example, one or more components of the system may use a crowdsourcing technique to obtain user-generated labels 212 for real and/or fake positions, in lieu of or in addition to generating labels 212 based on attributes of the corresponding positions and/or member profiles.

Training apparatus 200 uses features 210 and labels 212 to update parameters 214 of machine learning model 208. For example, training apparatus 200 may use a training technique and/or one or more hyperparameters to update parameters 214 (e.g., coefficients, weights, etc.) of machine learning model 208 based on features 210 and labels 212 for a set of member profiles. In addition, training apparatus 200 may update parameters 214 on a periodic (e.g., hourly, daily, etc.) basis and/or when a certain amount of training data is available. Training apparatus 200 may additionally store one or more sets of parameters 214 in data repository 134 and/or another data store for subsequent retrieval and use.

After parameters 214 of machine learning model 208 are created and/or updated, analysis apparatus 204 applies machine learning model 208 to additional features 224 associated with other member profiles to produce scores 232 that reflect the likelihoods that positions listed in the member profiles are fake. The member profiles may include some or all member profiles in the online community, such as member profiles that list a specific company as an employer, member profiles that list positions of a certain type or seniority, and/or member profiles that belong to a certain industry or geographic region.

To generate scores 232, analysis apparatus 204 may retrieve parameters 214 of machine learning model 208 from data repository 134 and use profile data 216 and/or user activity data 218 to generate and/or retrieve features 224 for member profiles to be scored by machine learning model 208. Analysis apparatus 204 may input each set of features 224 into machine learning model 208, and machine learning model 208 may output a score ranging from 0 to 1 representing the likelihood that the position in the corresponding member profile is fake. In other words, machine learning model 208 may classify a position in a member profile as real or fake based on a corresponding set of features 224 for the member profile.

Finally, management apparatus 206 may generate output based on scores 232. First, management apparatus 206 may use scores 232 to identify real positions 226 and fake positions 228 in the member profiles. For example, management apparatus 206 may apply a threshold to scores 232 so that positions with scores 232 that exceed the threshold are identified as fake positions 228 and positions with scores 232 that do not exceed the threshold are identified as real positions 226.

Management apparatus 206 may also store indications of real positions 226 and fake positions 228 in data repository 134 and/or another data store. For example, management apparatus 206 may add, to a record in the data store, a field and/or flag indicating whether the corresponding position is real or fake. In another example, management apparatus 206 may remove fake positions 228 from the data store and/or query results returned by the data store. In a third example, management apparatus 206 may store scores 232 in the data store to allow other entities (e.g., teams, customers, etc.) to apply custom thresholds for identifying real positions 226 and fake positions 228 based on scores 232. In a fourth example, management apparatus 206 and/or other entities may hide the member profiles or positions, block the member profiles, reduce the positions of the member profiles or positions in rankings (e.g., applicant rankings for jobs, rankings of connection recommendations, rankings of follow recommendations, etc.), and/or require additional verification of the positions before the positions are shown in the online community and/or the member profiles are used to access the online community.

Management apparatus 206 may further calculate one or more metrics 230 based on real positions 226 and fake positions 228 identified by machine learning model 208. For example, management apparatus 206 may remove fake positions 228 from calculations of metrics 230 for a given company, location, industry, and/or other grouping of members or member profiles. Such metrics 230 may include, but are not limited to, a number and/or proportion of members that share a given title or similar titles (e.g., Chief Executive Officer (CEO) title, C-level titles, Vice President titles, senior-level titles, mid-level titles, entry-level titles, management titles, engineering titles, etc.). The number and/or proportion may be calculated and/or grouped by company (e.g., total number or proportion of C-level positions at a company), location (e.g., total number or proportion of senior-level positions at a specific location in a company), industry (e.g., total number or proportion of Vice President positions in an industry), school (e.g., total number or proportion of graduates with a given title), company size (e.g., total number or proportion of upper management positions at companies with over 1,000 total employees), years of experience (e.g., total number or proportion of senior-level titles in employees with 10+ years of experience at a given company and/or industry), and/or other attributes.

Finally, management apparatus 206 may output real positions 226, fake positions 228, and/or metrics 230 for use in generating and/or analyzing insights related to positions occupied by members of the online community. For example, management apparatus 206 may include metrics 230 in a report, document, and/or user interface within a “Talent Insights” feature that is provided by and/or accessed through an online network. The “Talent Insights” feature may allow companies, talent acquisition leaders, and/or other entities to view information and/or insights related to talent pools, companies, and/or industries. Such information and/or insights may include, but are not limited to, the total number of employees, growth rate, attrition rate, and/or average tenure in a given talent pool, company, and/or industry; top roles or functions occupied by employees in the talent pool, company, and/or industry; and/or companies or industries to or from which employees move.

By identifying fake positions in member profiles based on attributes associated with the member profiles, the system of FIG. 2 may improve the accuracy of data listed in the member profiles and/or insights derived from the member profiles. In contrast, conventional techniques may typically identify fake member profiles and/or user accounts using other types of features and/or by generating labels in other ways. Consequently, the disclosed embodiments may improve computer systems and technologies related to use of online networks, verifying member profile data, and/or deriving insights from member profile data or online networks, as well as user engagement, user experiences, interaction, and/or value derived through the online networks, member profiles, and/or insights.

Those skilled in the art will appreciate that the system of FIG. 2 may be implemented in a variety of ways. First, training apparatus 200, analysis apparatus 204, management apparatus 206, data repository 134, and/or attribute repository 234 may be provided by a single physical machine, multiple computer systems, one or more virtual machines, a grid, a cluster, one or more databases, one or more filesystems, and/or a cloud computing system. Training apparatus 200, analysis apparatus 204, and management apparatus 206 may additionally be implemented together and/or separately by one or more hardware and/or software components and/or layers.

Second, different types of machine learning models and/or techniques may be used to generate scores 232. For example, the functionality of machine learning model 208 may be provided by a regression model, artificial neural network, support vector machine, decision tree, random forest, gradient boosting tree, naïve Bayes classifier, Bayesian network, clustering technique, deep learning model, hierarchical model, and/or ensemble model.

Moreover, the same machine learning model or separate machine learning models may be used to generate scores 232 for various groupings of members, member profiles, and/or positions. For example, different machine learning models and/or different versions of a machine learning model may be used to classify positions associated with different member segments, companies, industries, positions, seniorities, job titles, and/or regions as real or fake. In a second example, multiple machine learning models may be used with different sets of features (e.g., features 224) for a member profile or position to produce multiple scores that predict the likelihood that the position is fake. The scores may then be combined with a set of weights and/or inputted into an additional machine learning model or formula to obtain a final score that is used to determine if the position is real or fake.

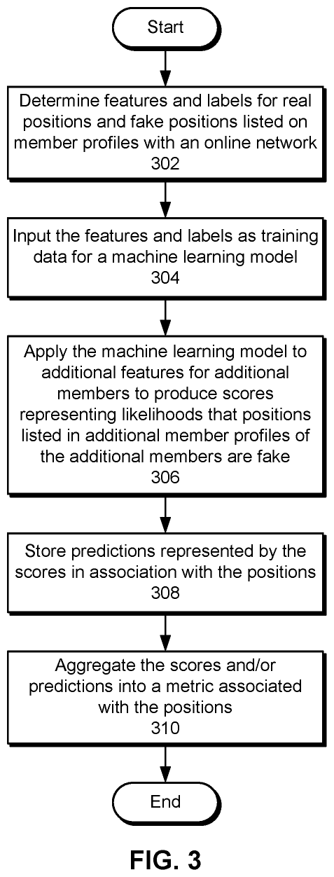

FIG. 3 shows a flowchart illustrating a process of identifying fake positions in member profiles in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, features and labels for real positions and fake positions listed in member profiles with an online network are determined (operation 302). For example, a position in a member profile may be labeled as fake based on a first threshold for a number of employees with the position at a company listed in the member profile and/or a second threshold for a number of connections associated with the member profile in the online network. A position in a member profile may be labeled as real based on a confirmed email address for a company, access to the online network through an IP address of the company, and/or other indicators of authentic and/or verified member profiles in the online network.

Next, the features and labels are inputted as training data for a machine learning model (operation 304). For example, the features and labels may be used to update the parameters of a regression model, support vector machine, tree-based model, and/or other type of classification model that determines if positions in member profiles are real or fake.

The machine learning model is applied to additional features for additional members to produce scores representing likelihoods that positions listed in additional member profiles of the additional members are fake (operation 306). For example, the machine learning model may output scores ranging from 0 to 1, with each score representing the probability that the position listed in the corresponding member profile is fake.

A number of features may be used with the machine learning model to perform such predictions. For example, the features may indicate inclusion or exclusion of an educational background, profile picture, and/or summary from a member profile; the visibility of a member profile (e.g., hidden or visible); a number of skills listed in a member profile; a number of connections at an employer listed in the member profile; a number of profile views of the member profile; a ratio of a type of position (e.g., C-level position, senior-level position, etc.) to all positions in a member profile; a number of positions listed in a member profile; and/or a capitalization of a name in the member profile (e.g., if letters in the member's name are all in uppercase or lowercase).

Predictions represented by the scores are then stored in association with the positions (operation 308). For example, a threshold may be applied to the scores to classify the corresponding positions as real or fake, and a record of each position and/or the corresponding member profile may be updated with an indicator (e.g., field, flag, etc.) that the position is real or fake. In another example, positions that are classified as fake may be removed from the corresponding member profiles and/or a data store containing the member profiles. In a third example, positions that are identified as fake may be filtered from results returned in response to queries of the data store.

Finally, the scores and/or predictions are aggregated into a metric associated with the positions (operation 310). For example, positions that are identified as real may be used to generate metrics such as a number of employees that share a title or similar titles within a company, a proportion of employees that share the title or similar titles within the company, the number of employees in the company, the growth rate of the company, the attrition rate of the company, and/or other values related to the company's employment and/or hiring trends. The same metrics may also, or instead, be calculated for other groupings of members or positions, such as industries, locations, schools, skills, years of experience, employment types, and/or roles.

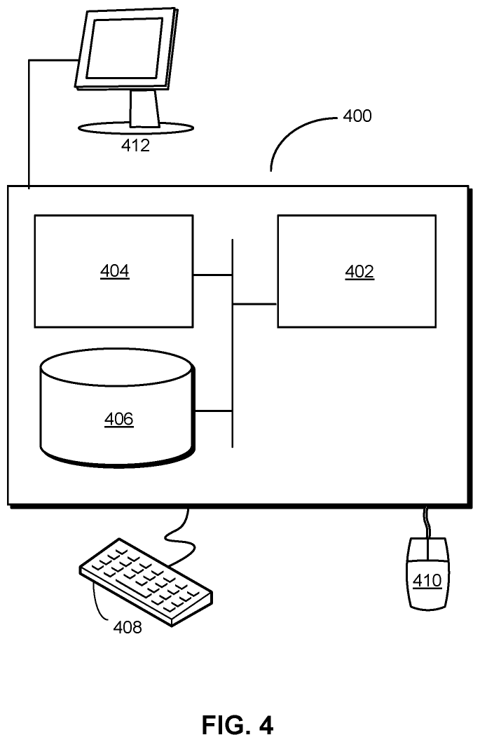

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for identifying fake positions in member profiles. The system includes a training apparatus, an analysis apparatus, and a management apparatus, one or more of which may alternatively be termed or implemented as a module, mechanism, or other type of system component. The training apparatus determines features and labels for real positions and fake positions listed in member profiles with an online network. Next, the training apparatus inputs the features and the labels as training data for a machine learning model. The analysis apparatus then applies the machine learning model to additional features for additional members with the online network to produce scores representing likelihoods that positions listed in additional member profiles of the additional members are fake. Finally, the management apparatus stores predictions represented by the scores in association with the positions and/or aggregates the scores or predictions into metrics associated with the positions.

In addition, one or more components of computer system 400 may be remotely located and connected to the other components over a network. Portions of the present embodiments (e.g., training apparatus, analysis apparatus, management apparatus, data repository, attribute repository, online network, etc.) may also be located on different nodes of a distributed system that implements the embodiments. For example, the present embodiments may be implemented using a cloud computing system that identifies fake positions in member profiles for a set of remote members of an online network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, by one or more computer systems, features and labels for real positions and fake positions listed in member profiles with an online network, wherein the features comprise inclusion of one or more attributes in the member profiles;
inputting, by the one or more computer systems, the features and the labels as training data for a machine learning model;
applying, by the one or more computer systems, the machine learning model to additional features for additional members with the online network to produce scores representing likelihoods that positions listed in additional member profiles of the additional members are fake; and
storing predictions represented by the scores in association with the positions.

2. The method of claim 1, further comprising:
aggregating the predictions into a metric associated with the positions.

3. The method of claim 2, wherein the metric comprises at least one of:
a number of employees that share a title within a company; and
a proportion of employees that share the title within the company.

4. The method of claim 1, wherein determining the features and the labels for the real positions and the fake positions listed in the member profiles with the online network comprises:
labeling a position in a member profile as fake based on a first threshold for a number of employees with the position at a company listed in the member profile and a second threshold for a number of connections associated with the member profile in the online network.

5. The method of claim 1, wherein determining the features and the labels for the real positions and the fake positions listed in the member profiles with the online network comprises:
labeling a position in a member profile as real based on a confirmed email address for a company and access to the online network through an Internet Protocol (IP) address of the company.

6. The method of claim 1, wherein the one or more attributes comprise at least one of:
an educational background;
a profile picture; and
a summary.

7. The method of claim 1, wherein the additional features comprise a visibility of a member profile.

8. The method of claim 1, wherein the additional features comprise at least one of:
a number of skills listed in a member profile;
a number of connections at an employer listed in the member profile; and
a number of profile views of the member profile.

9. The method of claim 1, wherein the additional features comprise a ratio of a type of position to all positions in a member profile.

10. The method of claim 1, wherein the additional features comprise at least one of:
a number of positions listed in a member profile; and
a capitalization of a name in the member profile.

11. The method of claim 1, wherein storing the predictions represented by the scores in association with the positions comprises:
storing an indicator of a real position or a fake position for a member of the online network.

12. The method of claim 1, wherein storing the predictions represented by the scores in association with the positions comprises:
filtering a subset of the positions with high likelihood of being fake in a data store.

13. A system, comprising:
one or more processors; and
memory storing instructions that, when executed by the one or more processors, cause the system to:
determine features and labels for real positions and fake positions listed in member profiles with an online network, wherein the features comprise inclusion of one or more attributes in the member profiles;
input the features and the labels as training data for a machine learning model;
apply the machine learning model to additional features for additional members with the online network to produce scores representing likelihoods that positions listed in additional member profiles for the additional members are fake; and
store predictions represented by the scores in association with the positions.

14. The system of claim 13, wherein the memory further stores instructions that, when executed by the one or more processors, cause the system to:
aggregate the predictions into a metric associated with the positions.

15. The system of claim 14, wherein the metric comprises at least one of:
a number of employees that share a title within a company; and
a proportion of employees that share the title within the company.

16. The system of claim 13, wherein determining the features and the labels for the real positions and the fake positions listed in the member profiles with the online network comprises:
labeling a first position in a first member profile as fake based on a first threshold for a number of employees with the position at a company listed in the first member profile and a second threshold for a number of connections associated with the first member profile in the online network; and
labeling a second position in a second member profile as real based on a confirmed email address for a company and access to the online network through an Internet Protocol (IP) address of the company.

17. The system of claim 13, wherein the one or more attributes comprise at least one of:
an educational background;
a profile picture; and
a summary.

18. The system of claim 13, wherein the additional features comprise at least one of:
a visibility of a member profile;
a number of skills listed in a member profile;
a number of connections at an employer listed in the member profile;
a number of profile views of the member profile; and
a ratio of a type of position to all positions in a member profile.

19. The system of claim 13, wherein the additional features comprise at least one of:
a number of positions listed in a member profile; and
a capitalization of a name in the member profile.

20. A non-transitory computer-readable storage medium storing instructions that when executed by a computer cause the computer to perform a method, the method comprising:
determining features and labels for real positions and fake positions listed in member profiles with an online network, wherein the features comprise inclusion of one or more attributes in the member profiles;
inputting the features and the labels as training data for a machine learning model;
applying the machine learning model to additional features for additional members with the online network to produce scores representing likelihoods that positions listed in additional member profiles for the additional members are fake; and
storing predictions represented by the scores in association with the positions.
